(19) United States
(12) Patent Application Publication
(10) Pub. No.: US 2013/0095006 A1
(43) Pub. Date: Apr. 18, 2013

(54) Laminar Flow Device

(71) Applicant: Yang-Te Hsu, Guishan Township (TW)

(72) Inventor: Yang-Te Hsu, Guishan Township (TW)

(21) Appl. No.: 13/273,280

(22) Filed: Oct. 14, 2011

(51) Int. Cl. B01L 3/00; G21K 5/08

(52) U.S. Cl. 422/500; 250/432 R

(57) ABSTRACT

A laminar flow device including a containing body and an air circulating unit is disclosed. The containing body is separated into a first containing part and a second containing part, with a surrounding wall of the first containing part having a processing window, with a cover being capable of sealing the processing window, and with the cover having a transparent part. The air circulating unit is received in the second containing part and expels low-temperature air into the first containing part.

### BACKGROUND OF THE INVENTION

1. Field of the Invention

The present invention relates to a laminar flow device and, more particularly, to a laminar flow device capable of providing a low-temperature, dustless, and aseptic environment.

2. Description of the Related Art

Conventionally, in order to prevent undesired spread of cultured bacteria or viruses and also to prevent the experimental targets from external contaminants, bio-trials are usually carried out in an environment of particular conditions such as low-temperature, dustlessness and asepsis, so as to protect the experimenter and lower the error of result due to the external contaminants.

Specifically, most bio-trails such as protein extraction, cytological trial and histo-trial has to be performed at a low temperature, and some of them performed with enzymes or specific reagents have even to be processed in a critical range of low temperature to avoid disadvantages due to external and high temperature and humidity such as protein degradation, inactive enzyme, and cell/tissue degeneration.

For example, conventionally, protein extraction is performed by pouring a desired number of fragmental ice blocks into a container and then inserting a test tube that receives cells or tissues between the ice blocks in the container, so as to perform the protein extraction. However, not only an additional ice machine for making the fragmental ice has to be prepared, but also processes for making the ice may further result in additional time, water and power consumption. Besides, the test tube may not be firmly positioned by the ice blocks since the ice blocks may melt into water, and thus the liquid with the cells or tissues may be poured out or contaminated.

Moreover, the container should be big enough to receive a lot of ice when it takes much time for processing the bio-trail. However, this big container may be bigger than the capacity of a conventional laminar flow device, and a test tube exposed to the air in a normal room may be contaminated by the floating dust. Therefore, a new laminar flow device is needed to solve the above problems.

### SUMMARY OF THE INVENTION

It is therefore the primary objective of this invention to provide a laminar flow device to establish a low-temperature environment for bio-trial.

Another objective of this invention is providing a laminar flow device to establish a dustless and aseptic environment for bio-trial, so as to avoid floating dust.

Still another objective of this invention is providing a laminar flow device to save the cost and additional time, water and power consumption for manufacture of ice blocks.

The invention discloses a laminar flow device including a containing body and an air circulating unit. The containing body is separated into a first containing part and a second containing part, with a surrounding wall of the first containing part having a processing window, with a cover being capable of sealing the processing window, and with the cover having a transparent part. The air circulating unit is received in the second containing part and expels low-temperature air into the first containing part.

The invention further discloses that the first and second containing parts are separated by a partition, the first containing part has a processing room and the second containing part has a receiving room in communication with the processing room, and two openings are formed in the partition for airflow to pass through.

The invention further discloses that the transparent part is made of a transparent material, and a plurality of defogger lines is formed on the transparent part.

The invention further discloses that a light emitting member is mounted on the inner wall of the first containing part and the light emitting member comprises an ultraviolet sterilizer and an illuminative light, with the ultraviolet sterilizer capable of irradiating UV light and the illuminative light capable of irradiating visible light respectively.

The invention further discloses that the air circulating unit comprises a compressor module, a temperature-regulating module and an autoclave-sterilizing module, which are all positioned on the partition, with the temperature-regulating module arranged at one of the two openings to inhale the air in the processing room, and with the autoclave-sterilizing module arranged at the other opening and sterilizing the inhaled air.

The invention further discloses that an air tube is further comprised, wherein the air tube has an end connecting with the autoclave-sterilizing module and another end communicating with the processing room to expel the low-temperature air.

The invention further discloses that the cover is pivotably coupled with an edge defining the processing window.

The invention further discloses that the cover is coupled with a balancing module.

The invention further discloses that the balancing module comprises a chain, a gear wheel set and a weight, two ends of the chain are respectively connected with the cover and the weight, and the gear wheel set movably hold the chain for the chain to slide.

The invention further discloses that a controller electrically is connected with the air circulating unit and attached to an outer face of the second containing part.

The invention further discloses that a plurality of wheels is arranged beneath the containing body.

The invention further discloses that a first auxiliary window and a second auxiliary window in the surrounding wall of the first containing part are formed, with both of the first and second auxiliary windows communicating with the processing room and capable of being sealed by covers.

The invention further discloses that the first auxiliary window is formed beneath the processing window while the cover capable of sealing the first auxiliary window is in the form of a sliding door.

The invention further discloses that an additional second auxiliary window is formed, with the two second auxiliary windows formed on two opposite sides of the first containing part.

The invention further discloses that at least one socket is arranged in the first containing part.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a perspective view of a laminar flow device according to a first embodiment of the invention.

FIG. 2 shows a cross-sectional view of the laminar flow device of the first embodiment of the invention.

FIG. 3 shows a cross-sectional view of a laminar flow device of a second embodiment of the invention.

FIG. 4 shows a cross-sectional view of the laminar flow device of the second embodiment of the invention in use.

In the various figures of the drawings, the same numerals designate the same or similar parts. Furthermore, when the term “first,” “second,” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

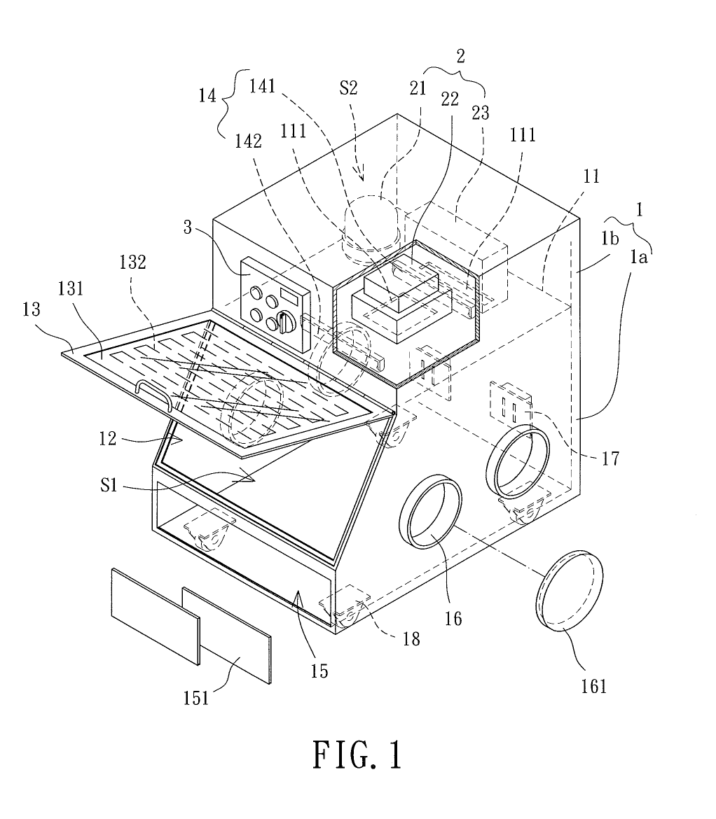

FIG. 1 shows a laminar flow device according to a first embodiment of the invention, which includes a containing body 1 and an air circulating unit 2 received inside the containing body 1 to maintain a low-temperature environment in the containing body 1, with the said “low-temperature” having a temperature degree lower than 25□ and preferably between 1-8□.

The containing body 1 is preferably made of acrylic ester, so as to provide advantages such as light and qualified performances in pressure resistance and high temperature resistance. In this embodiment, a partition 11 is positioned inside the containing body 1 to separate the inner room of the containing body 1 into a first containing part 1a and a second containing part 1b, with the first containing part 1a forming a processing room S1 and the second containing part 1b forming a receiving room S2 in communication with the processing room S1. In this embodiment, there are two openings 111 formed in the partition 11 for airflow to pass through, while a filter may be formed across one of the opening 111 taken as an air inlet to filter out the floating dust in the inhaled air and maintain the quality of the air in the processing room S1. Specifically, the first containing part 1a is made of transparent and acrylic material.

A surrounding wall of the first containing part 1a has a processing window 12 with a cover 13 capable of sealing the processing window 12. In this embodiment, the processing window 12 is preferably formed in an inclined face of the surrounding wall for a user to conveniently put objects into the processing room S1 or perform biological processes therein via the processing window 12. Preferably, the cover 13 is pivotably coupled with an edge defining the processing window 12, while the cover 13 further has a transparent part 131 made of glasses, with a plurality of defogger lines 132 formed on an inner side of the transparent part 131 to heat the cooled surface of the transparent part 131 of the cover 13 for defogging. Alternatively, for the same reason, the inner side of the transparent part 131 can also be formed of a nano surface to avoid the adhesion of sweat.

Additionally, there can be at least one light emitting member 14 inside the first containing part 1a, which may include an ultraviolet sterilizer 141 and an illuminative light 142 mounted on the inner wall of the first containing part 1a, preferably mounted on an bottom face of the partition 11, so that the ultraviolet sterilizer 141 and illuminative light 142 can irradiate UV light and visible light respectively in the processing room S1. It should be noted that the light emitting member 14 is mainly provided to produce the UV light and visible light, so that a position in which the light emitting member 14 is arranged can be any position in the first containing part 1a as long as the UV light of the ultraviolet sterilizer 141 and the visible light of the illuminative light 142 can be casted to objects inside the processing room S1.

Referring to FIG. 1 again, there are a first auxiliary window 15 and a second auxiliary window 16 in the surrounding wall of the first containing part 1a, both of them communicating with the processing room S1, while the first auxiliary window 15 can be sealed by a cover 151 and the second auxiliary window 16 can be sealed by another cover 161. In this embodiment, the first auxiliary window 15 is formed beneath the processing window 12 while the cover 151 is in the form of a sliding door for the user to stretch hands into the processing room S1 through the first auxiliary window 15. The second auxiliary window 16 is formed on a part of the surrounding wall that is adjacent to the inclined face where the processing window 12 formed, and the second auxiliary window 16 is provided for another user to stretch hands into the processing room S1 so as to assist the performance of biological processes. Preferably, there can also be a plurality of second auxiliary windows 16, such as two second auxiliary windows 16 formed on two opposite sides of the first containing part 1a, and any one of them that is not in use can be sealed by the cover 161.

Furthermore, there can also be at least one socket 17 in the first containing part 1a so as to supply any object that has to be electrically actuated with electrical power. Besides, there can be a plurality of wheels 18 beneath the containing body 1 for convenience in movement.

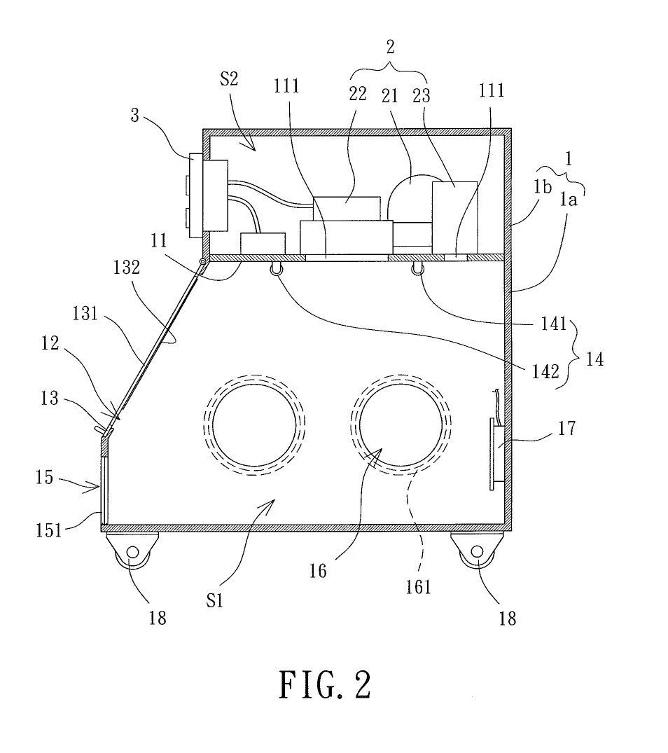

Please further refer to FIGS. 1 and 2. The air circulating unit 2 is received inside the second containing part 1b and expels air with low temperature into the first containing part 1a. In this embodiment, the air circulating unit 2 includes a compressor module 21, a temperature-regulating module 22 and an autoclave-sterilizing module 23, which are positioned on the partition 11 and connect with each other. The temperature-regulating module 22 is preferably arranged at one of the openings 111 to inhale the air in the processing room S1, and the autoclave-sterilizing module 23 expels cool and sterilized air into the processing room S1 through the other opening 111. Specifically, the air inhaled by the temperature-regulating module 22 initially passes through the filter to get rid of the floating dust therein, and then the temperature of the inhaled air is lowered by the temperature-regulating module 22. Finally, the low-temperature air is sterilized by the autoclave-sterilizing module 23 before entering the processing room S1. Additionally, a dehumidifier can be interconnected between the temperature-regulating module 22 and the autoclave-sterilizing module 23.

Please be noted that the air circulating unit 2 is adapted to lower the temperature of the inhaled air, preferably to 1-8□, and to remove dust and to sterilize. Any kind of conventional machine used capable of such functions is suitable for use in this invention, and thus the way in which the air circulating unit 2 performs is not limited.

Please refer to FIG. 1 still. There can be a controller 3 electrically connected with the air circulating unit 2 and preferably attached to an outer face of the second containing part 1b, so that the user can adjust the temperature of the air passing through the air circulating unit 2.

The above illustrated laminar flow device has the following adventures. First, with the air circulating unit 2, the air in the processing room S1 of the first containing part 1a can be continuously cooled and dehumidified to maintain its temperature at about 1-8□, so that the environment of the processing room S1 is qualified for biological processes. Second, the defogger lines 132 can efficiently prevent the adhesion of sweat caused by temperature difference, so as to provide a clear view for the user when a bio-trail is carried out. Therefore, not only the time consumption and cost for manufacture of fragmental ice blocks are avoided, but a low-temperature, dustless and aseptic environment is maintained, so that the result of the bio-trail is accurate.

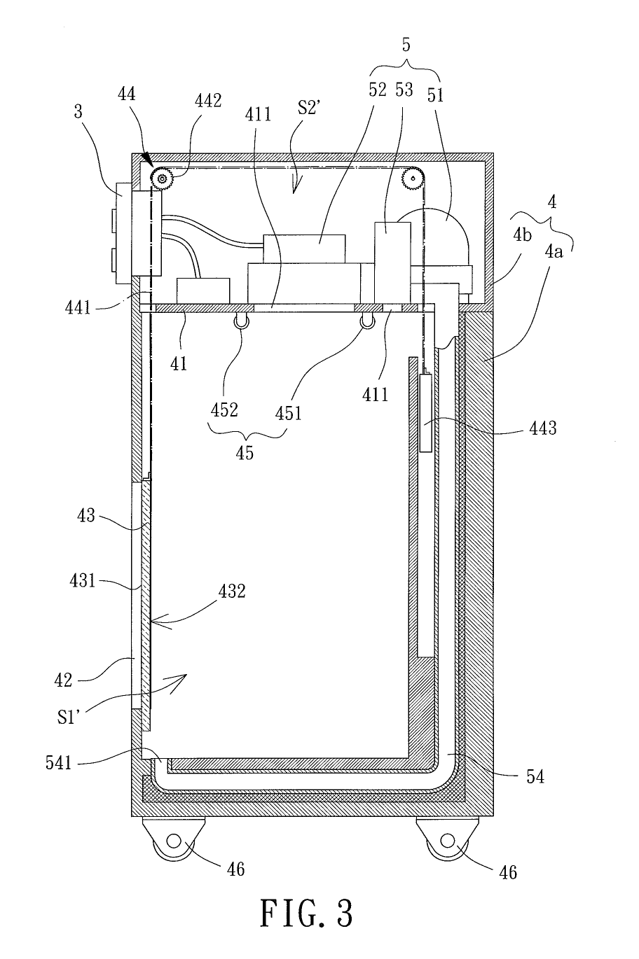

Referring to FIG. 3, which shows a laminar flow device according to a second embodiment of the invention, with this laminar flow device also including a containing body 4 and an air circulating unit 5 received inside the containing body 4 to maintain a low-temperature environment in the containing body 4.

The containing body 4 is separated into a first containing part 4a and a second containing part 4b by a partition 41, and a surrounding wall of the first containing part 4a has a processing window 42 with a cover 43 capable of sealing the processing window 42, with the first containing part 4a forming an processing room S1′ and the second containing part 4b forming a receiving room S2′ in communication with the processing room S1′. The difference between the containing body 4 of this embodiment and the containing body 1 of the first embodiment lies in that the cover 43 of the containing body 4 is coupled with a balancing module 44, and thus the balancing module 44 can keep the position of the cover 43 relative to the processing window 42. Specifically, the balancing module 44 has a chain 441, a gear wheel set 442 and a weight 443. Two ends of the chain 441 are respectively connected with the cover 43 and the weight 443. The gear wheel set 442 is adapted to movably hold the chain 441 for the chain 441 to slide.

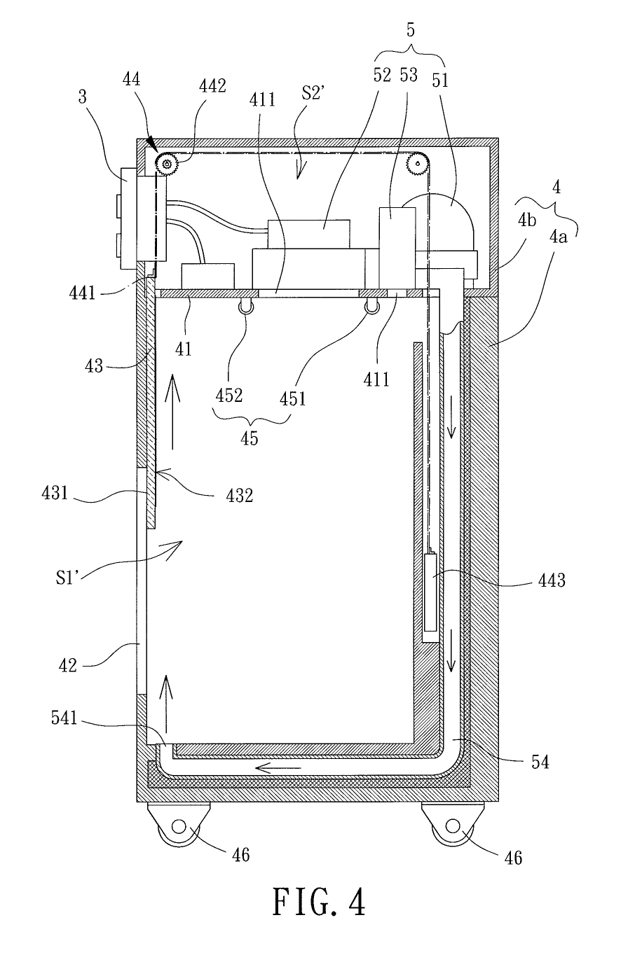

Now please refer to FIGS. 3 and 4. The air circulating unit 5 includes a compressor module 51, a temperature-regulating module 52 and an autoclave-sterilizing module 53, so as to expel low-temperature, dustless and aseptic air into the first containing part 4a and maintain the dustless and aseptic environment of the processing room S1′. The difference between the air circulating unit 5 of this embodiment and the air circulating unit 2 of the first embodiment lies in that an additional air tube 54 is used, with an end of the air tube 54 connecting with the autoclave-sterilizing module 53 and the other end of the air tube 54, which serves as a free end 541, communicating with the processing room S1′. The air tube 54 is specifically used to guide the expelled air to a desired part of the processing room S1′. Particularly, the free end 541 is preferably arranged adjacent to a lower edge of the processing window 42 and jets out the expelled air upwards. Therefore, since the pressure of the expelled air is larger than that of the air outside the containing body 4, the outside air is prevented from entering the containing body 4 via the processing window 42.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A laminar flow device, comprising:
a containing body separated into a first containing part and a second containing part, with a surrounding wall of the first containing part having a processing window, with a cover being capable of sealing the processing window, and with the cover having a transparent part; and
an air circulating unit received in the second containing part and expelling low-temperature air into the first containing part.

2. The laminar flow device as claimed in claim 1, wherein the first and second containing parts are separated by a partition, the first containing part has a processing room and the second containing part has a receiving room in communication with the processing room, and two openings are formed in the partition for airflow to pass through.

3. The laminar flow device as claimed in claim 1, wherein the transparent part is made of a transparent material, and a plurality of defogger lines is formed on the transparent part.

4. The laminar flow device as claimed in claim 1, wherein a light emitting member is mounted on the inner wall of the first containing part and the light emitting member comprises an ultraviolet sterilizer and an illuminative light, with the ultraviolet sterilizer capable of irradiating UV light and the illuminative light capable of irradiating visible light respectively.

5. The laminar flow device as claimed in claim 2, wherein the air circulating unit comprises a compressor module, a temperature-regulating module and an autoclave-sterilizing module, which are all positioned on the partition, with the temperature-regulating module arranged at one of the two openings to inhale the air in the processing room, and with the autoclave-sterilizing module arranged at the other opening and sterilizing the inhaled air.

6. The laminar flow device as claimed in claim 5 further comprising an air tube, wherein the air tube has an end connecting with the autoclave-sterilizing module and another end communicating with the processing room to expel the low-temperature air.

7. The laminar flow device as claimed in claim 1, wherein the cover is pivotably coupled with an edge defining the processing window.

8. The laminar flow device as claimed in claim 1, wherein the cover is coupled with a balancing module.

9. The laminar flow device as claimed in claim 8, wherein the balancing module comprises a chain, a gear wheel set and a weight, two ends of the chain are respectively connected with the cover and the weight, and the gear wheel set movably hold the chain for the chain to slide.

10. The laminar flow device as claimed in claim 1 further comprising a controller electrically connected with the air circulating unit and attached to an outer face of the second containing part.

11. The laminar flow device as claimed in claim 1, wherein a plurality of wheels is arranged beneath the containing body.

12. The laminar flow device as claimed in claim 2, wherein a first auxiliary window and a second auxiliary window in the surrounding wall of the first containing part are formed, with both of the first and second auxiliary windows communicating with the processing room and capable of being sealed by covers.

13. The laminar flow device as claimed in claim 12, wherein the first auxiliary window is formed beneath the processing window while the cover capable of sealing the first auxiliary window is in the form of a sliding door.

14. The laminar flow device as claimed in claim 12, wherein an additional second auxiliary window is formed, with the two second auxiliary windows formed on two opposite sides of the first containing part.

15. The laminar flow device as claimed in claim 1, wherein at least one socket is arranged in the first containing part.
